(19) United States
(12) Patent Application Publication
(10) Pub. No.: US 2011/0264541 A1
(43) Pub. Date: Oct. 27, 2011

(54) GENERATION AND DISTRIBUTION OF USER STRUCTURED WEB CONTENT AND ADVERTISEMENT, BY CREATING A DATABASE MATRIX CLOUD ACROSS THE INTERNET

(76) Inventor: SANOF DEEN MOHAMEDSADAKATHULLA, DUBLIN, CA (US)

(21) Appl. No.: 12/949,814

(22) Filed: Nov. 19, 2010

Related U.S. Application Data
(60) Provisional application No. 61/327,593, filed on Apr. 23, 2010.

(51) Int. Cl. G06Q 30/00

(52) U.S. Cl. 705/14.73

(57) ABSTRACT

A database matrix cloud across the internet that enables the generation and distribution, of organized user structured interlinked web content and advertisement to any webpages, comprising of interlinked database matrix tables for each topic, created interactively by web users, and embedded in any number of webpages. The database matrix cloud allows for real-time simultaneous and concurrent access, updating and storing of the content, for display, interaction, access and filtering by any web users. The data and content available from the database matrix cloud enables to create new websites with rich user dynamic content instantaneously, and allowing for growth and expansion of the content through unlimited websites. The database matrix cloud allows interlinked database matrix table banners or links to be created and embedded in any webpages, when clicked, opens the interlinked database matrix table, allowing the web users to obtain content and targeted advertisements.

### CROSS-REFERENCE TO RELATED APPLICATIONS

The present application is based on U.S. Provisional patent application entitled “Generation and distribution of user structured web content and advertisement, by creating a database matrix cloud across the internet” application Ser. No. 61/327,593, filed Apr. 23, 2010, which is hereby incorporated by reference in its entirety.

### BACKGROUND OF THE INVENTION

The field of the invention relates to creating an interlinked dynamic web content database generated by the web users, in a structured and organized way. Such content database would be distributed to any number of websites across the internet, by embedding the user created content database in any webpages. This allows for the interlinked content database to exist across the internet in any number of webpages, allowing for simultaneous and concurrent access and growth and expansion of the structured interlinked content.

The internet has evolved exponentially over the last decade, and there exists a wide choice of search engines for the web users to search for web content and information, for knowledge or shopping experience. However, the content and information provided by the search engines may not be clearly organized or structured as needed by the web users searching for such content, but possibly based on certain algorithms that identify sites to be displayed based on their popularity, or keyword relevance, etc.

There are numerous advertisement serving applications like Google AdSense, kontera, which generate advertisements based on the context of the web page content, and may not be what the web users are exactly looking for. Also, the advertisements are created by the advertiser looking to promote their product, and as such, these advertisements do not have any additional content or value such as comparing them with competitor products in one page, hence the web users would need to search several websites to compare such products, which is very time consuming, in order to obtain the desired content information and knowledge, for better shopping value and experience. Organizing and structuring such content based on certain specific criteria of the web user, may not be possible, using the current available methods.

Creating a new website without any content can be done easily, using many site building tools available on the internet. However, creating a new website with rich real-time dynamic content and data takes significant effort and resources.

### BRIEF SUMMARY OF THE INVENTION

The aim of this invention is to implement an interlinked dynamic web content database, created using software and tools, which display organized and structured web content, created based on the interactivity of the web users, whereby such content could be filtered, searched, sorted and updated by any web users to obtain desired results. Such dynamic content and advertisement which is created in a structured method and displayed across the internet, would be distributed and embedded across the internet in any web pages in any websites, thereby creating an interlinked web content database across the internet, which any web users in any websites can access, filter and update. Thus, such user content and advertisement in the web content database, could be accessed and updated real-time by any web users, thereby growing the user content and advertisement database, while also delivering organized and structured content and targeted advertisements, resulting in enhancing the web content browsing, as well as focused shopping search, value and experience for the web users. Such organized and structured content could be interleaved with directed or focused advertisement created by the web users, who generated the content. Such advertisement created by the web users, would be exactly relevant to the context of the content available in that web page.

Creating a new website with rich dynamic content to get user traffic, requires a lot of time and effort from the website and content developers. As the interlinked web content database contains a continuously expanding and growing structured dynamic web content, that could be distributed and embedded in any websites, allowing simultaneous and concurrent access and content availability, this invention allows to create or generate new websites with rich dynamic user content instantaneously, using software program and tools with minimal effort. Such newly created websites will become a part of the interlinked web content database across the internet, thus allowing user content access and update in real-time.

### BRIEF DESCRIPTION OF THE DRAWINGS

FIG. 1 describes the overview of the interlinked database matrix cloud, consisting of the interlinked database matrix tables, embedded and displayed in any number of webpages across the internet.

FIG. 2 shows a more detailed view of primary i-Matrix table and secondary i-Matrix table in the interlinked database matrix cloud.

FIG. 3 shows the interlinking of the i-Matrix tables within an i-Matrix table domain creating an i-Matrix table domain cloud.

FIG. 4 is an overview flow diagram of the present invention, illustrating the process of creating the interlinked database matrix cloud.

FIG. 5 is a more detailed flowchart of the process of creating the primary and secondary i-Matrix tables, thereby creating an interlinked database matrix cloud.

FIG. 6 is detailed flowchart of the process of creating structured web content and advertisement in the i-Matrix cloud, as well as application of the i-Matrix cloud to create new websites and i-Matrix advertisement banners.

FIG. 7 illustrates the 3-dimensional representation of the interlinked database matrix cloud, showing webpages embedded with the primary and secondary i-Matrix tables.

FIG. 8 illustrates an example of a Recipes primary i-Matrix table.

FIG. 9 illustrates an example of the derived secondary i-Matrix tables from the Recipes primary i-Matrix table.

FIG. 10 illustrates the Recipes i-Matrix table domain cloud, showing the webpages embedded with the primary Recipes i-Matrix table and the derived secondary i-Matrix tables.

### DETAILED DESCRIPTION OF THE INVENTION

The following definitions are provided for this disclosure with the intent of providing a common lexicon. A database table is a set of data elements or values, which are organized as a pre-determined number of columns identified by each column label, and as many number of expandable rows or records, as data is entered. The database table is generated using a specialized software program and tools running in a computer server, according to the web users specifications, for each topic. A database matrix is an array of database tables with expandable rows and columns, as the database tables are created and added to the database matrix.

The database tables in the database matrix are linked to each other within each column and between different columns, based on specific criteria, and this each database table in the database matrix is referred to as the interlinked database matrix table. The database matrix array comprising of the interlinked database matrix tables is referred to as the interlinked database matrix 102, hereinafter referred to as i-Matrix in this disclosure.

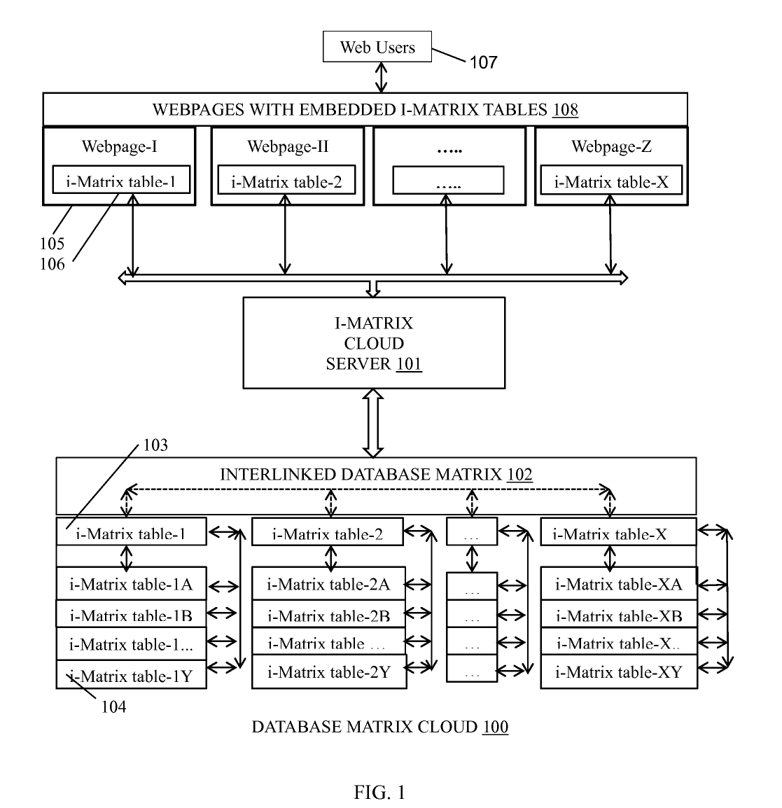

This invention relates to generating dynamic structured user content and advertisement, created interactively by the web users, and relates to a method implemented in software for interactively creating an i-Matrix table 103, 104, based on web users 107 specification, and storing the user content and advertisements in the i-Matrix table, as well as techniques for filtering, distributing and displaying such structured data stored in the i-Matrix table in a plurality of any number of web pages, for any web users to access and update real-time, thereby creating an interlinked database matrix cloud 100, across the internet. FIG. 1 describes the overview of the database matrix cloud 100, consisting of i-Matrix tables 103, embedded 108 and displayed in any number of webpages across the internet.

The database matrix cloud 100, is an interlinked network of i-Matrix tables 103, embedded in a plurality of any number of webpages and websites 105, and is stored in an i-Matrix cloud server 101. This interlinked network of webpages across the internet 105, consisting of the embedded i-Matrix tables 106, forms the i-Matrix cloud. The i-Matrix cloud server 101, consist of physical computer servers running specialized software tools to generate and store the i-Matrix tables, and manage the i-Matrix cloud. The i-Matrix tables are distributed or embedded 108 in any number of pluralities of webpages, for web users display and interaction. The i-Matrix tables can be viewed or updated by any number of web users simultaneously, and this would update the i-Matrix tables in the i-Matrix cloud server concurrently, thereby displaying the updated data in all the i-Matrix tables, embedded in any webpages across the internet, thereby forming a database matrix cloud 100, across the internet.

An i-Matrix table contains web users generated contents organized as columns and rows. Each row in the i-Matrix table represents a record or a set of related data. The web users can add contents and the number of rows is expandable to unlimited addition of web contents. The entire i-Matrix table contents can be searched, and each column can be alphanumerically sorted in ascending or descending fashion. Each row of records can have unique or multiple description page which could display additional details provided by the web users, in addition to the record data entry, tailored for that specific row of data entry record. For example, an i-Matrix table containing one thousand rows or records of entry can have unique one thousand or more description pages, with one or more unique pages representing each row or record of entry. Multiple rows of records could also be linked to one description page, thus an i-Matrix table having one thousand rows of records, of which one hundred of those rows could have one unique or the same description page.

The i-Matrix table can be filtered based on any keyword or criteria. The entire i-Matrix table can be searched globally, or each column can be selectively searched with unique column search field. Each column can be alphanumerically sorted in ascending or descending fashion. Data values in the columns can be added, appended or distributed to any other columns.

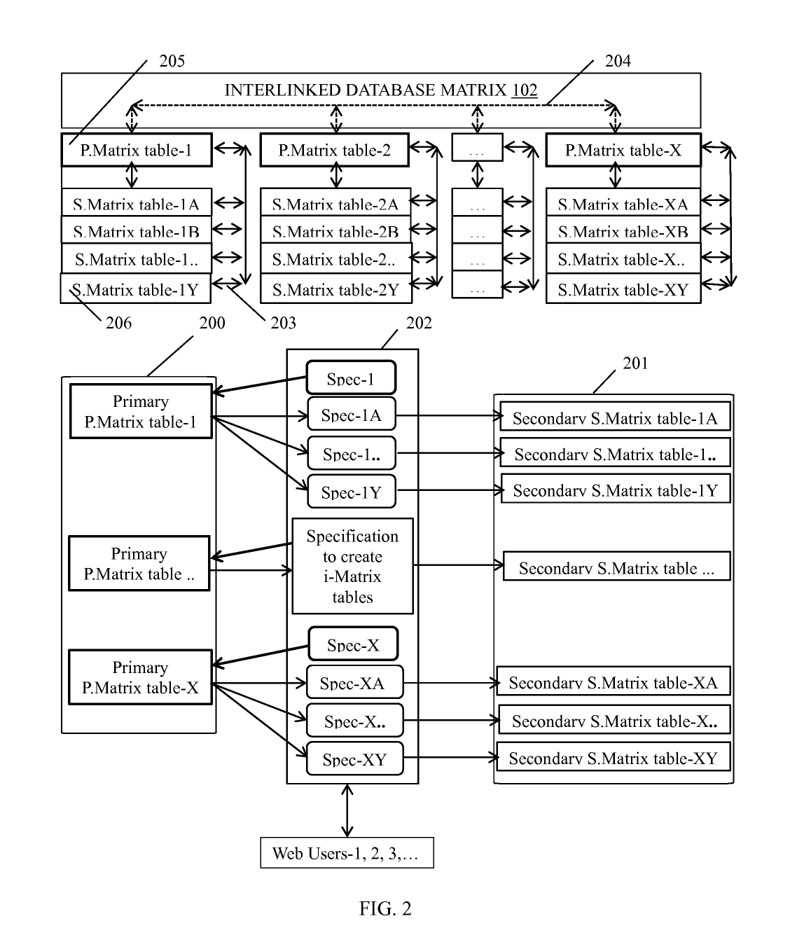

FIG. 2 shows a more detailed view of primary i-Matrix tables 205 and secondary i-Matrix tables 206 in the interlinked database i-Matrix 102. An i-Matrix table can be a primary i-Matrix table 200 or a secondary i-Matrix table 201, and each specific topic or subject of interest will have a unique primary i-Matrix table 200. A primary i-Matrix template is created for each unique topic of interest, by the i-Matrix server, according to the web users specifications 202. A primary i-Matrix table 200, also referred to as P.Matrix table in this disclosure, encompasses all column fields and all row records, created for the topic or subject.

A secondary i-Matrix table 201, also referred to as S.Matrix table in this disclosure, can be generated as a derivative of the primary i-Matrix table 200, depending on the sub category of the original topic or subject of interest, according to the web users specifications 202. A secondary i-Matrix table can have desired column fields selectively generated from the primary i-Matrix table depending on the subject category, hence hiding undesired or unnecessary columns. Additionally, a secondary i-Matrix table can also be created by filtering rows and/or columns based on certain criteria, while having all column fields from the primary i-Matrix table. All the secondary i-Matrix table derived from one primary table will be interlinked to each other 203. In certain cases, different primary i-Matrix tables may be interlinked 204, thereby interlinking the relevant secondary tables derived from those different primary i-Matrix tables.

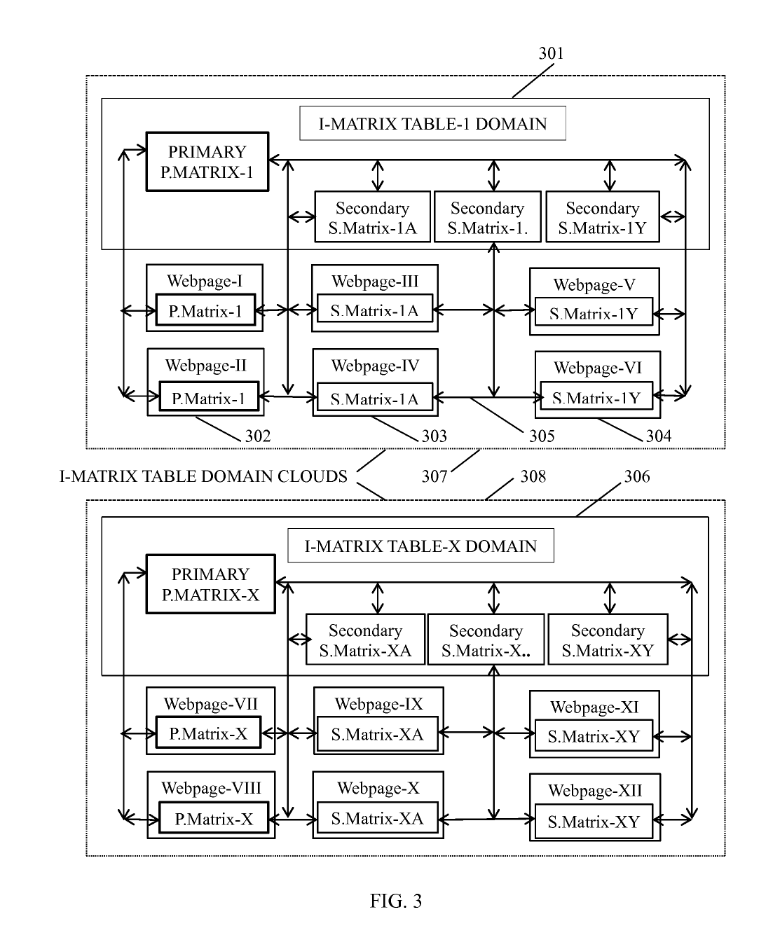

FIG. 3 shows the interlinking 305 of the i-Matrix tables within an i-Matrix table domain 301, 306 creating i-Matrix table domain clouds 307, 308. Each topic could have a specific i-Matrix table. There will be one unique primary i-Matrix table for a unique topic or subtopic. Each primary i-Matrix table can have any number of derived secondary i-Matrix tables. All the secondary i-Matrix tables derived from a single primary i-Matrix table will be grouped under that unique primary i-Matrix table domain 301, 306. All the webpages that have the i-Matrix tables embedded from that particular primary i-Matrix table domain will form a unique primary i-Matrix table domain cloud 307, 308. All the i-Matrix tables within a single i-Matrix table domain cloud are interlinked 305, hence if a particular i-Matrix table is updated with new data entry, then that update will be reflected across that domain cloud in all webpages embedded with the i-Matrix tables, from the same i-Matrix table domain cloud. Each primary or secondary i-Matrix table can be embedded in any number of webpages, allowing any number of web users to access and update the same i-Matrix table from multiple webpages, at the same time.

An instance of the i-Matrix table is defined as the embedding of the single i-Matrix table in a webpage. Hence there will be any number of instances of a single i-Matrix table, primary or secondary, embedded in any number of webpages across the internet. Updating of an instance of the i-Matrix table will update all the instances of the same i-Matrix table, as well as all the i-Matrix instances within the same i-Matrix table domain cloud. FIG. 3 illustrates two instances of P.Matrix-1 embedded in webpages-I and II. Updating each instance of P.Matrix-1 in either webpage-I or II will update all the instances of the primary and secondary i-Matrix table-1, embedded in any number of webpages in that i-Matrix table-1 domain cloud 301.

FIG. 3 illustrates the i-Matrix table domain clouds 307, 308 with two different i-Matrix table domain, i-Matrix table-1 domain 301 and i-Matrix table-X domain 306. The i-Matrix table-1 domain 301 consists of the primary i-Matrix table 302 labeled as P.Matrix-1 and the derived secondary i-Matrix table 303, 304 labeled as S.Matrix-1A, 1B, . . . , 1Y, where Y can be any number, that grows as more secondary i-Matrix tables are derived from the primary i-Matrix table.

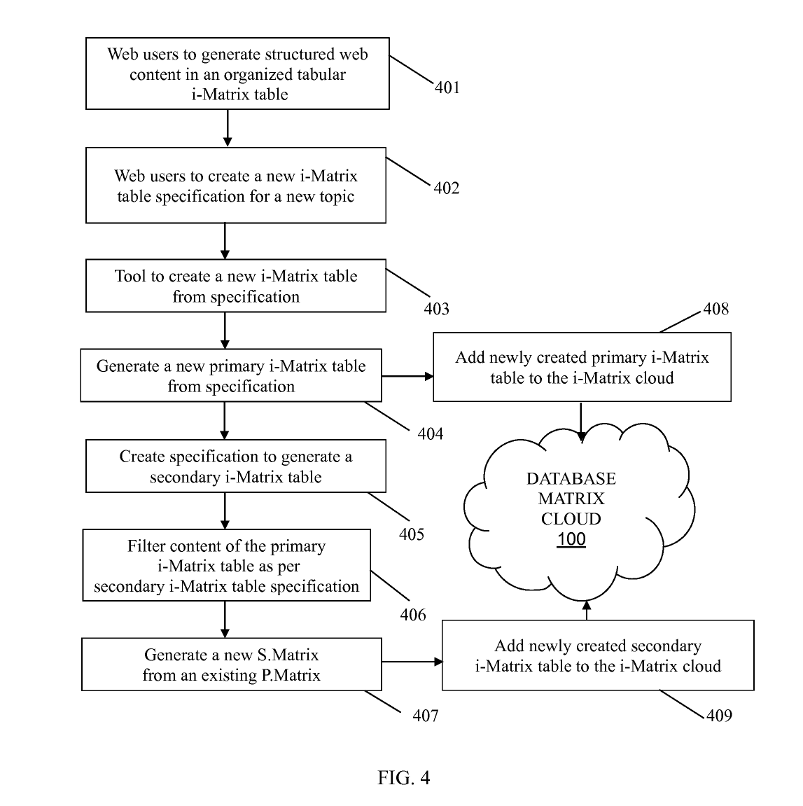

FIG. 4 is an overview flow diagram, illustrating the process of creating the interlinked database matrix cloud 100. In order for the web users to generate structured web content in an organized tabular i-Matrix table 401, the web users provide the specification to create a new primary i-Matrix table template for a new topic 402. Using the software programs and tools in the i-Matrix server to create a new i-Matrix table from specification 403, a new primary i-Matrix table is generated 404. The web users can create specifications to generate secondary i-Matrix tables from the primary i-Matrix table 405. The secondary i-Matrix specification describes the rows and columns and content of the primary i-Matrix, which would need to be filtered 406, to generate a new secondary i-Matrix from the existing primary i-Matrix table 407. The newly created primary i-Matrix table and/or the secondary i-Matrix tables would be added to the i-Matrix cloud 408, 409.

A secondary i-Matrix table 407 can be generated as a derivative of the primary i-Matrix table, depending on the sub category of the original topic or subject of interest. A secondary i-Matrix table can have desired rows and column fields 406 selectively generated from the primary i-Matrix table depending on the subject category, hence hiding undesired or unnecessary columns. Additionally, a secondary i-Matrix table can also be created by filtering rows 406 based on certain criteria, while having all column fields from the primary i-Matrix table. The primary i-Matrix 408 and the secondary i-Matrix 409 will become part of the database matrix cloud 100.

A primary i-Matrix table can have additional knowledge based columns and content, added automatically by the i-Matrix server, using software program and tools. This is done by referring to an already existing internal i-Matrix table in the i-Matrix server, or other i-Matrix tables created by web users, containing relevant data knowledge and related content value residing in the i-Matrix server, and populating the primary i-Matrix table with related data values added automatically by the server, based on the user content input by the web users. Such method would add additional columns which are populated automatically by the i-Matrix server, based on the web content entered by the web users. This would allow additional value added data, added automatically by the i-Matrix server in the i-Matrix table, without any manual entry by the web user. Such method adds additional value and knowledge and related content to the i-Matrix table. This allows the possibility of interlinking of different primary i-Matrix tables 204 and their relevant secondary i-Matrix tables, between different i-Matrix table domain clouds.

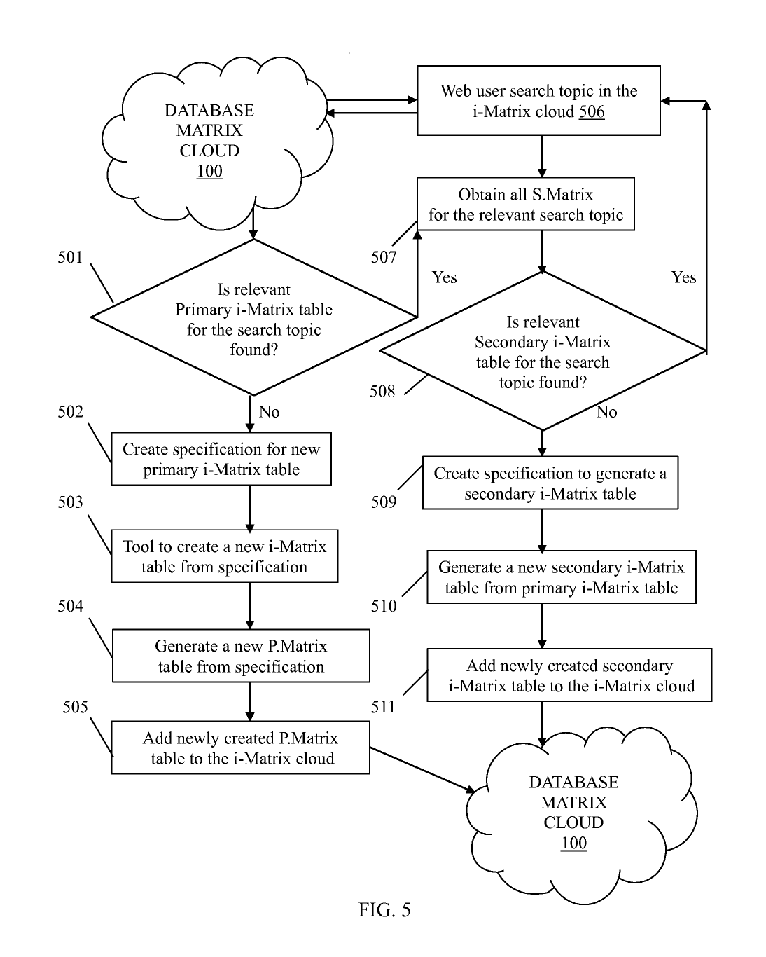

FIG. 5 is a more detailed flowchart of the process of creating the primary 505 and secondary 511 i-Matrix tables, thereby creating a database matrix cloud 100. A web user can search for desired topic in the i-Matrix cloud 506. The search can return a relevant primary i-Matrix table 501 for the desired search topic. If the web user wishes to add more content in this topic or create secondary i-Matrix table for this topic, the web user may search for all secondary i-Matrix table 507 to find if the content or i-Matrix table already exists 508. If it does not exist, then web user can create specification to generate a new secondary i-Matrix table 509, and the tool or software program in the i-Matrix server, could be used to generate a new secondary i-Matrix table from the primary i-Matrix table 510. If the relevant primary i-Matrix table was not found 501 in the web user search, then the web user could create specification for a new primary i-Matrix table 502 for the topic or subject of interest. Using the software tool 503 to create a new i-Matrix table from specification, a new primary i-Matrix table is generated 504. Such newly created primary and secondary i-Matrix tables will become part of the database matrix cloud 505, 511.

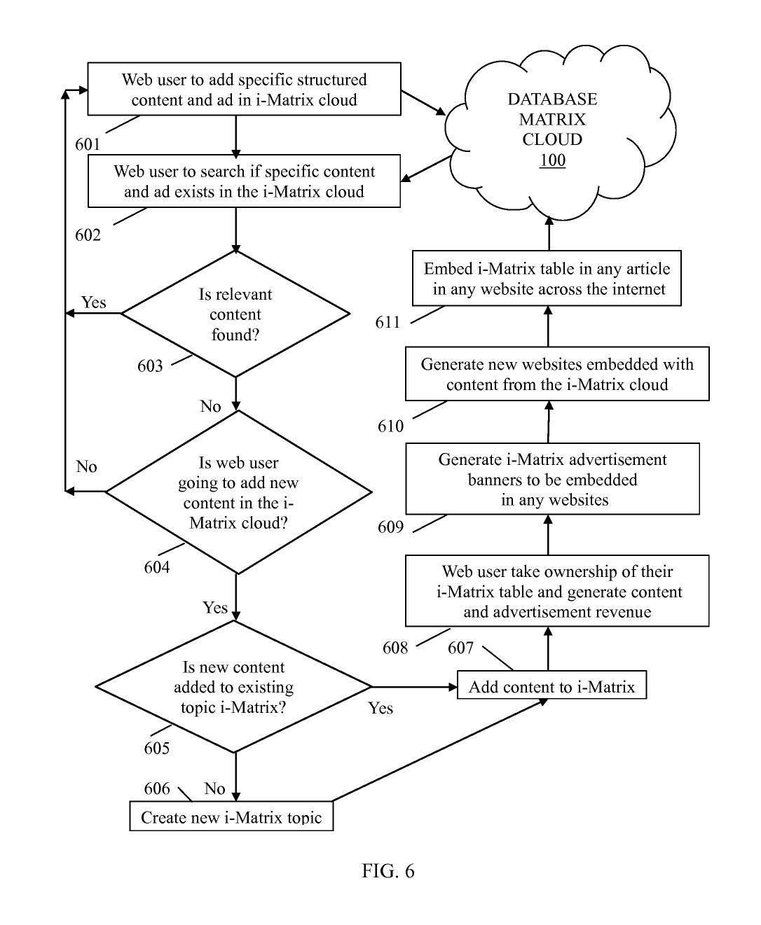

FIG. 6 is detailed flowchart of the process of creating structured web content and advertisement in the i-Matrix cloud 100, as well as application of the i-Matrix cloud to create new websites 610 and i-Matrix advertisement banners 609. This illustrates how the web users can interactively add specific structured content and advertisement in the i-Matrix cloud 601. Web users can search the i-Matrix cloud to check if any specific content they may wish to add already exists in the i-Matrix cloud 602. If relevant content and advertisement is found 603, then the web user may wish to search for different content. However, if the relevant content and advertisement is not found, 603, then the web user could add new content and advertisement in the i-Matrix cloud 604. In order to add new content to existing topic i-Matrix table 605, a new i-Matrix table topic is created 606. If new content needs to be added to the existing i-Matrix table 605, the web user can then add that content to the i-Matrix 607.

Another embodiment of this invention allows advertisement application such as i-Matrix table banners or links to be created and embedded in any websites across the internet 610, 611, which when clicked by the browsing web users in the embedded website, can open the i-Matrix table with structured content, and such i-Matrix banners 609 could be related to the web page context or pre-determined by the websites owner, which allows the browsing web users to obtain content as well as receive the targeted advertisements from the i-Matrix cloud. Such i-Matrix advertisement banners 609 available from the i-Matrix cloud could be displayed in any websites across the internet, allowing web content and advertisement to be distributed to any websites 609, 610.

An i-Matrix table is created according to web users specifications. The software in the i-Matrix server provides a way for the web users who created a specific i-Matrix table, to own that specific i-Matrix table 608 and either allow or disallow other web users from updating or adding content and advertisement to that specific i-Matrix table. Additionally, the software in the i-Matrix server provides a way for each individual creator of a specific i-Matrix table of a specific topic or subject and the associated content and advertisement created within that specific i-Matrix table, to own, carry and distribute their primary and derived secondary i-Matrix tables to multiple websites, as well as own the revenue generated through their content and advertisements including affiliate marketing links or advertisements, from that specific i-Matrix table 608.

The primary i-Matrix table or the derived secondary i-Matrix table can be embedded in an article in any website 611, or anywhere the website owner wants to embed, in any website or webpages across the internet. The i-Matrix table with the entire contents will be displayed on the embedded position in the website. The web users can access, filter, search, and sort the entire contents of the embedded i-Matrix table. The web users can add new records or content to the i-Matrix table from the embedded website, which will concurrently update the relevant primary i-Matrix table in the i-Matrix server, allowing all distributed and embedded relevant primary and secondary i-Matrix tables across the internet to be updated real-time. This means that the structured content can be distributed and accessed across the internet in any website simultaneously, creating an interlinked database matrix cloud 100 across the internet. An embodiment of this technique allows the creation or generation of new websites with rich dynamic structured web content instantaneously 610, as the i-Matrix cloud contains a continuously expanding and growing structured content that could be distributed and embedded in any websites, allowing simultaneous and concurrent access and content availability.

Web users can interactively enter content data into the i-Matrix table, using an i-Matrix table data entry form, specific to the topic or subject of interest. The form will contain fields that can be displayed in the i-Matrix table, as well as fields that can be hidden in the i-Matrix table, but can be displayed in the description page, for that particular row of record. This allows web users to generate more detailed content, as well as include or attach affiliate network based advertisement banners relevant to the content or create their own advertisement banners that can be displayed in the description page for that particular row or record. Images and media can be displayed in the i-Matrix table as well, or hidden in the i-Matrix table while displayed in the description page.

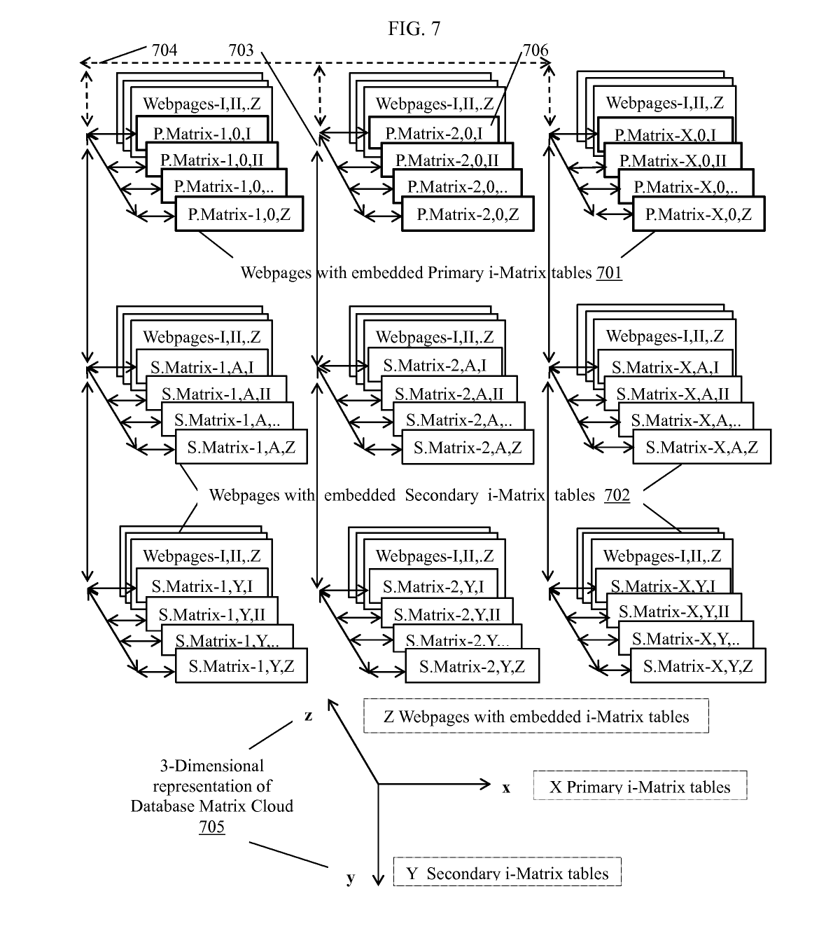

FIG. 7 illustrates the 3-dimensional representation of the interlinked database matrix cloud 705, showing webpages embedded with primary i-Matrix tables 701, and webpages embedded with secondary i-Matrix tables 702. The 3-axis are represented by x, y and z axis, where x-axis represent the Primary i-Matrix tables, y-axis represent the derived secondary i-Matrix tables from each primary i-Matrix table, and the z-axis represent the multiple webpages embedding the primary or the secondary i-Matrix tables. The primary i-Matrix are represented by 1, 2, 3 . . . X, where X is any finite number representing the total number of primary i-Matrix tables existing in the i-Matrix. The secondary i-Matrix tables are represented by A, B, C, . . . , Y, where Y is any finite number representing the number of secondary i-Matrix tables derived for each primary i-Matrix table, existing in the i-Matrix. The different webpages are represented by I, II, III, IV . . . Z, where Z is any finite number representing the number of webpages for each primary or secondary i-Matrix table.

The i-Matrix cloud consists of any number of webpages across the internet, embedded with the i-Matrix tables. FIG. 7 shows the components of the interlinked database matrix cloud. The primary i-Matrix table 706 for each topic are represented in the first row of the i-Matrix, as represented by 1, 2, . . . , X, embedded in any number of webpages 1, II, III, . . . , Z.

Each primary i-Matrix table can have any number of derived secondary i-Matrix tables, represented as A, B . . . Z, derived based on the web users specification. Hence, each column will form a unique i-Matrix table domain cloud for a specific topic, consisting of the corresponding single primary i-Matrix table existing in the first row, and any finite number of the derived secondary i-Matrix tables in the y-axis, embedded in any number of webpages in the z-axis. There will be a yz-axis cloud plane existing for each column, which consist of all the webpages embedding the relevant primary i-Matrix tables and all the corresponding derived secondary i-Matrix tables. This plane for each column will form the i-Matrix table domain cloud for that specific topic. There will be as many i-Matrix table domain clouds are there are primary i-Matrix tables, as each primary i-Matrix table will form its own i-Matrix domain cloud. Based on the representation used in FIG. 7, there will be X number of i-Matrix table domain clouds, and each i-Matrix table domain cloud would have Y number of secondary i-Matrix tables, and each i-Matrix table having Z number of instances of that specific i-Matrix table, embedded in Z number of webpages. This 3-dimensional representation using the xyz-axis, with the x-axis for the primary i-Matrix tables, y-axis for the secondary i-Matrix tables, and z-axis for the embedded webpages forms the database matrix cloud 705.

An i-Matrix table domain cloud may be independent, without any data interlinking with other domain clouds. An i-Matrix table domain cloud may be dependent, with data interlinking with other domain clouds, as represented by the dashed line arrow 704, between the different primary i-Matrix tables. The interlinking 703 of the primary and the secondary i-Matrix tables within an i-Matrix table domain cloud, is illustrated in FIG. 7. For each i-Matrix table, there can be any number of instances of the single i-Matrix table embedded in any number of webpages across the internet 706. Updating of an instance of the i-Matrix table will update all the instances of the same i-Matrix table, as well as all the i-Matrix instances within the same i-Matrix table domain cloud.

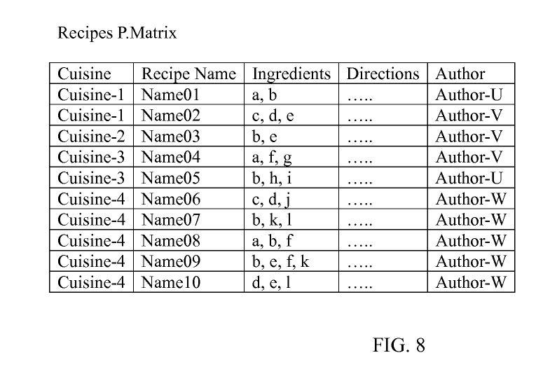

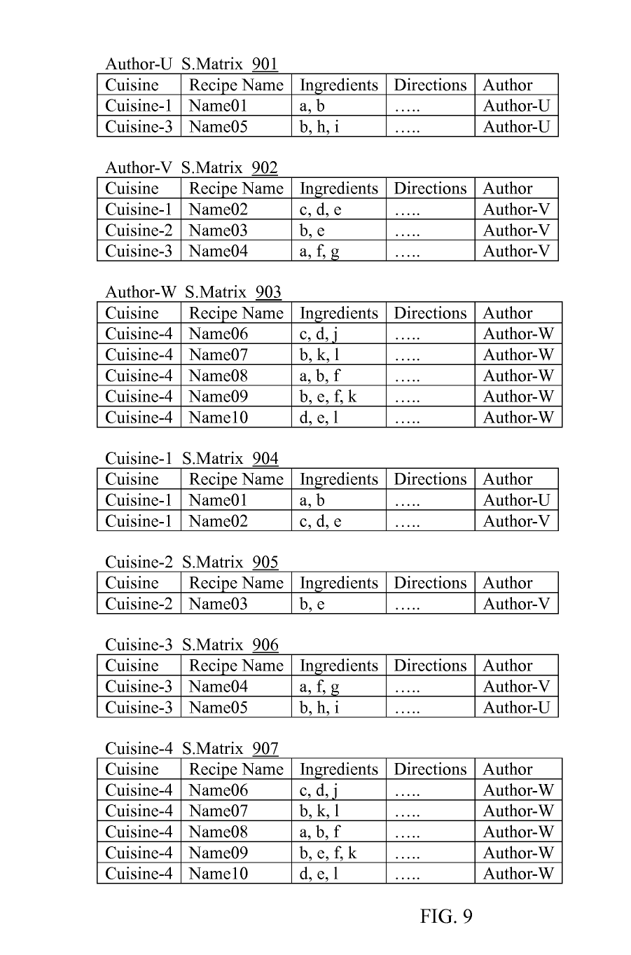

The present invention is illustrated by the following simple example. A web user intending to create an i-Matrix table for listing recipes, creates the specification to generate the recipes i-Matrix table such as columns fields and data types, etc. The software and tools in the i-Matrix server takes this specification and creates the recipes i-Matrix table. This recipes i-Matrix table will be the primary i-Matrix table, also referred to as the Recipes P.Matrix. The column fields specified by the web user could include fields such as cuisine, recipe name, ingredients, directions, and author. The Recipes P.Matrix is now part of the i-Matrix. Any web user could create entries in the Recipes P.Matrix under their unique author name. For illustration purpose, Recipes P.Matrix in FIG. 8 shows three different web users or authors, Author-U, Author-V, Author-W, that provided their recipe entries into the table. The three different authors or web users may wish to create their own website and list their recipe entries in their website. Based on these web users specifications, three different secondary i-Matrix tables can be created, that filter the recipes based on the three author names, Author-U S.Matrix 901, Author-V S.Matrix 902, Author-W S.Matrix 903. Also, secondary i-Matrix tables could be derived depending on the cuisine, or any specific criteria. For example, if there are four different cuisines, then four different secondary i-Matrix tables, Cuisine-1 S.Matrix 904, Cuisine-2 S.Matrix 905, Cuisine-3 S.Matrix 906, Cuisine-4 S.Matrix 907 could be derived based on each of these four different cuisines. Hence in this example, Recipes P.Matrix has seven different secondary i-Matrix tables derived based on author names and cuisine, as illustrated in FIG. 9.

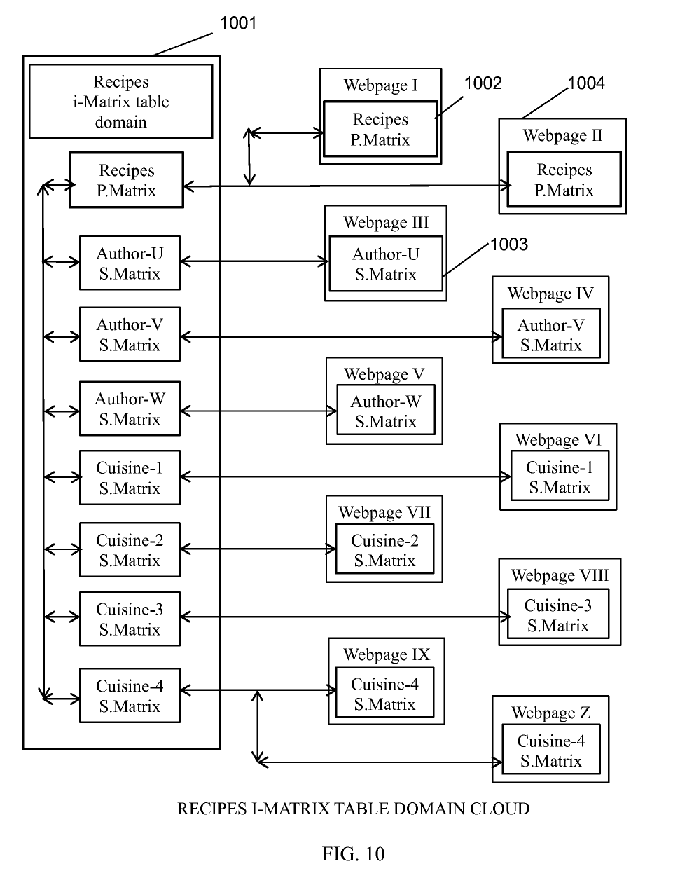

Based on this concept, any number of secondary i-Matrix tables could be derived from a primary i-Matrix table, depending on the different fields or keywords etc. Each of the primary recipes i-Matrix table or the derived secondary recipes i-Matrix tables could be embedded in any number of webpages across the internet. Updating any specific i-Matrix table in any one webpage will update the corresponding primary i-Matrix table and subsequently will update all the i-Matrix tables in this specific i-Matrix table domain cloud across the internet. FIG. 10 illustrates the above described example, showing the Recipes i-Matrix table domain 1001, consisting of the Recipes P.Matrix, and the seven derived S.Matrix, based on the different author names and cuisines. Webpages represented by I, II . . . Z shows the embedded primary and secondary i-Matrix tables. The primary Recipes P.Matrix 1002 is embedded 1004 in webpages-I and II. The seven secondary S.Matrix 1003 are embedded in webpages-III to Z.

Embodiments of the present invention can be illustrated using the Recipes i-Matrix table example, as described below. The Recipes P.Matrix table domain cloud or in general, the database matrix cloud across the internet, enables the generation and distribution, of organized user structured interlinked recipes content, or any content in general, and targeted advertisement to any webpages, created interactively by any web users or recipes authors, and embedded and interlinked in any number of webpages across the internet. The i-Matrix cloud allows the real-time simultaneous and concurrent access, updating and storing of the recipes content or any content in general, for display, interaction, access and filtering, by any web users, in any number of webpages.

The Recipes P.Matrix table domain cloud enables the recipes data and content, stored in the i-Matrix cloud, to create new recipes websites, with rich user recipes content instantaneously, and allowing for simultaneous and concurrent access and growth and expansion of the recipes content. In general, the database matrix cloud enables any dynamic i-Matrix content websites to be created instantaneously, by embedding the relevant i-Matrix table in the newly created website.

The Recipes P.Matrix table domain cloud enables to create i-Matrix table banners or links, that could be displayed or embedded in any webpages, which when clicked, opens the recipes i-Matrix table, for example, a derived secondary i-Matrix table showing heart healthy recipes, allowing the browsing web users to obtain the specific content, as well as receive any targeted advertisements such as heart healthy supplements available from the heart healthy recipes secondary i-Matrix table.

The Recipes P.Matrix table domain cloud or in general the database matrix cloud, enables each web user to generate a new primary and/or derived secondary i-Matrix tables from the available primary i-Matrix tables, and to create the associated content and advertisement for that specific i-Matrix table, and to own, carry and distribute their primary and derived secondary tables to multiple websites, as well as own the revenue generated through their content and advertisements, from that specific i-Matrix table. The revenue may be generated using a subscription model, affiliate network marketing and advertisement, web based advertisement revenue, etc.

Another embodiment of the present invention allows the creation of a network of webpages with embedded i-Matrix tables from the i-Matrix cloud, that allows communication, data transfer and display, between any number of web users and webpages, to be updated instantaneously, in each and all of the specific network of webpages in the i-Matrix cloud. For example, if there exists one thousand web users or members in a specific, say soccer club i-Matrix table domain cloud, then the i-Matrix table for this specific soccer club will be embedded in each and all of its one thousand member webpages, allowing communication and data transfer between the thousand members instantaneously, through their own personal webpages. This means each of the thousand members can have their own webpages or websites, with the embedded soccer club i-Matrix table in each website, allowing communication between the members.

This concept could be extended for any topic or content, allowing any number of i-Matrix table domain clouds existing across the internet, for any number of topic or category, with any number of web users communicating within specific groups or networks of webpages. Hence, for example, if there are one thousand soccer clubs globally, each having one hundred members, there will be one thousand primary i-Matrix tables, one for each soccer club, embedded in each of the one hundred members webpages for all the thousand clubs, allowing each of the hundred members for each soccer club to communicate within their own soccer club group. Thus there will be one thousand soccer club networks of webpages, each network having one hundred members webpages. Each of these i-Matrix tables that are embedded in the one hundred thousand webpages (thousand soccer club with hundred members each), could be displayed to any browsing web users or password protected for display only to each club's registered members.

What is claimed is:

1. A database matrix cloud created across the internet, comprising of the interlinked database matrix or the i-Matrix, consisting of the primary i-Matrix tables, the derived secondary i-Matrix tables for each primary i-Matrix table, based on the web users specification, with any number of each i-Matrix table instances embedded and interlinked in any number of webpages across the internet, forming i-Matrix table domain clouds for each primary i-Matrix table.

2. A database matrix cloud from claim 1, which enables:
the generation and distribution, of organized user structured interlinked web content and advertisement to any webpages, comprising of the primary i-Matrix tables for each topic, and the derived secondary i-Matrix tables, created interactively by the web users, and embedded and interlinked in any number of webpages across the internet;
the real-time simultaneous and concurrent access, updating and storing of the organized user structured interlinked web content and advertisement, for display, interaction, access and filtering, by any web users, in any number of webpages.

3. The database matrix cloud from claim 1, that further enables the data and content, stored in the i-Matrix tables in the i-Matrix cloud, to create new websites with rich dynamic, embedded i-Matrix table user content instantaneously, and allowing for simultaneous and concurrent access and growth and expansion of the structured interlinked user content and advertisement, in the newly created websites, and all i-Matrix embedded websites.

4. The database matrix cloud from claim 1, that further enables to create i-Matrix table advertisement banners or links, that could be displayed or embedded in any webpages, which when clicked, opens relevant i-Matrix table, allowing the browsing web users to obtain the interlinked structured user content, as well as receive the targeted advertisements from the database matrix cloud.

5. The database matrix cloud from claim 1, that further enables a way for each web user to create, own and distribute their primary and derived secondary i-Matrix tables to multiple websites and users, as well as generate revenue using any method, through their created content, links and advertisements, from their i-Matrix table.

6. The database matrix cloud from claim 1, that further enables the creation of a network of webpages with embedded i-Matrix table instances from the i-Matrix cloud, that allows communication, data transfer and display, between any number of web users and webpages, to be updated instantaneously, in each and all of the specific network of webpages in the database matrix cloud.
